(19) United States
(12) Patent Application Publication
(10) Pub. No.: US 2022/0268094 A1
(43) Pub. Date: Aug. 25, 2022

(54) E-AUTO DOOR BOTTOM

(71) Applicant: Baron Carleton, Tualatin, OR (US)

(72) Inventor: Baron Carleton, Tualatin, OR (US)

(21) Appl. No.: 17/679,153

(22) Filed: Feb. 24, 2022

Related U.S. Application Data
(60) Provisional application No. 63/153,078, filed on Feb. 24, 2021.

(51) Int. Cl. E06B 7/21; H01F 7/124; H01F 7/126

(52) U.S. Cl. CPC E06B 7/21; H01F 7/124; H01F 7/126; H01F 7/16

(57) ABSTRACT

A door sealing mechanism includes a solenoid for operating a cam mechanism to extend or retract a spring mechanism, causing a seal to engage/disengage with a floor/threshold, for allowing ease of opening/closing of the door while still providing sealing when the door is closed.

### CROSS-REFERENCE TO RELATED APPLICATIONS

This application claims benefit of U.S. provisional patent application Ser. 63/153,078 filed Feb. 24, 2021, entitled E-AUTO DOOR BOTTOM.

### BACKGROUND

This disclosure relates to doors, and more particularly to doors that seal when closed to block airflow, sounds, and lights from passing by or underneath the door.

In some environments, it is desirable to have doors that seal against airflow, sounds, and lights when closed, such as in medical or lab environments where the transfer of air, noise, and light from one side of a door to the other is to be minimized. Existing doors typically have a mechanism that lowers the door as it closes, such that a seal on the bottom of the door engages with the floor or a threshold to provide a seal. Such doors can require a significant amount of strength to begin to open, as the seal is firmly engaged when the door is first moved. The friction of the seal vs. the floor/threshold must be overcome to begin to move the door so that the internal mechanism will start to lift and disengage the seal. This can make it hard for persons to operate the door and causes issues with compliance with regulations and laws that govern ease of access for disabled persons. It can also create code compliance issues as the operation begins before the door is closed. This causes the bottom of the door to catch and drag on the floor and may prevent the door from properly closing, creating liabilities for fire code compliance, privacy exposure, and security risks.

### SUMMARY

In accordance with the disclosure, a mechanism for retracting and extending a door seal is provided that will automatically and immediately retract the seal from engagement when a door is to be opened and will automatically extend the seal on closing after a predetermined time.

The present technology's subject matter is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a perspective view of a door bottom sealing mechanism in an open, unsealed position;

FIG. 2 is a perspective view of a door bottom sealing mechanism in a closed, sealed position;

FIG. 3 is a perspective view of components of the mechanism with door components removed; and

FIG. 4 is a view of the door mechanism of FIGS. 1-3 taken in the direction of 4-4 on FIG. 1 where the mechanism is installed in a door in a mortise configuration; and

FIG. 5 is an end view of an alternative door mechanism where the mechanism is mounted to an external face of a door.

### DETAILED DESCRIPTION

According to a preferred embodiment of the present disclosure, the system comprises an electrically controlled mechanism to raise and lower a door seal on the bottom of a door when the door is to be opened or when the door is closed.

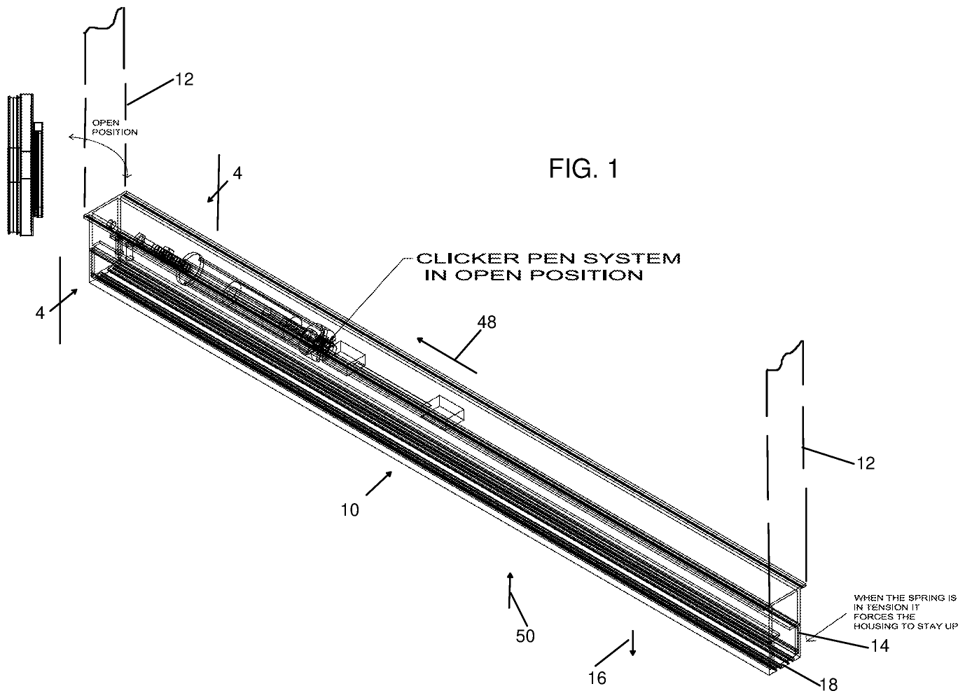

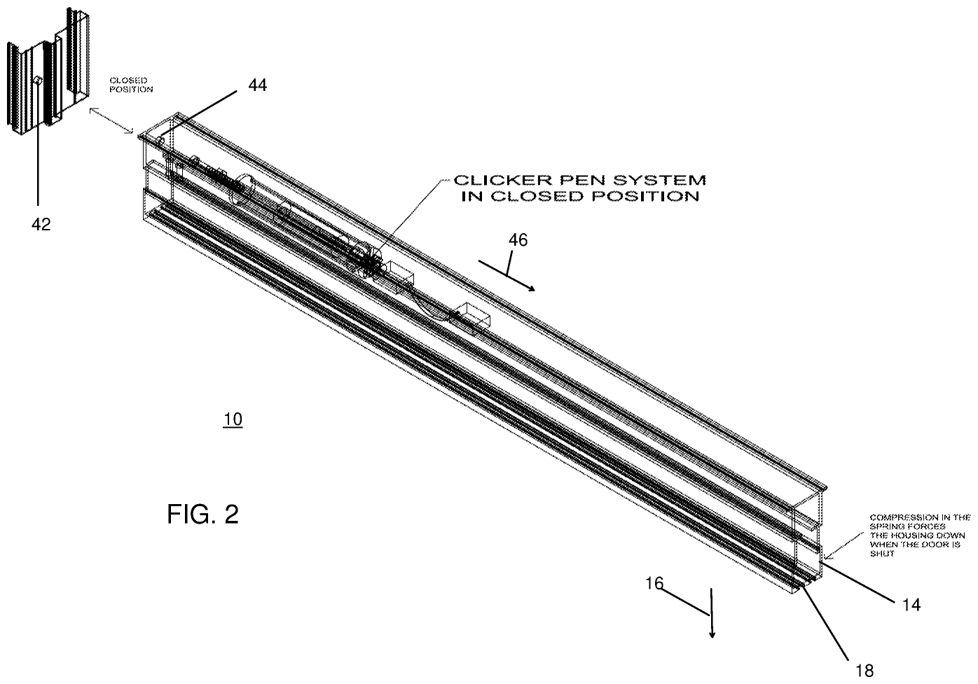

Referring now to FIG. 1, a perspective view of a door bottom sealing mechanism in an open, unsealed position, and FIG. 2, a perspective view of a door bottom sealing mechanism in a closed, sealed position, the mechanism 10 is mounted at the bottom of a door 12 (illustrated in phantom), and includes a movable housing 14 that can move up or down in the direction of arrow 16 to move a seal member 18 either away from engagement with a floor/threshold or into engagement with the floor/threshold.

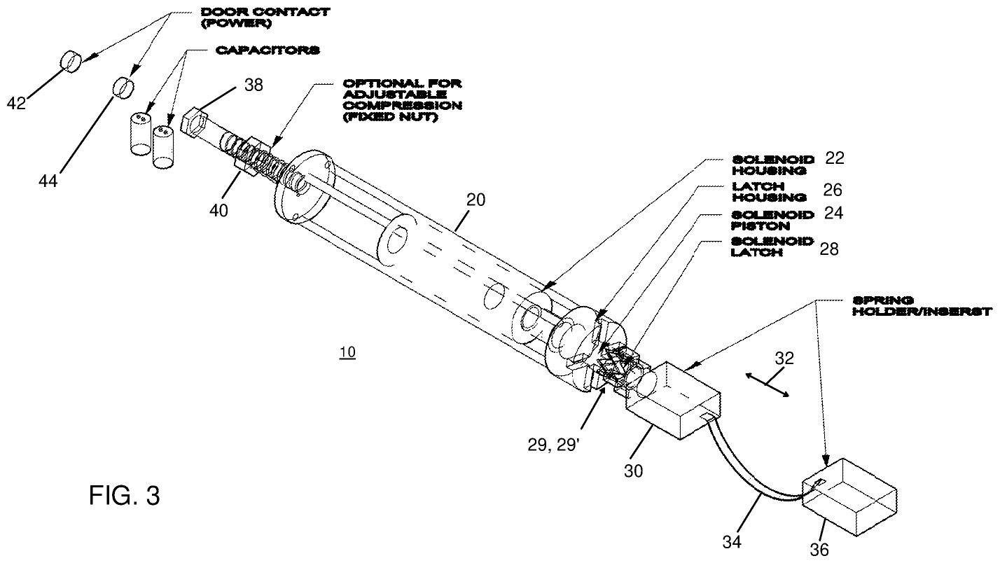

FIG. 3 is a perspective view of components of the mechanism with door components removed, illustrating the components of the moving mechanism. A solenoid 20 is mounted in a housing 22 that secures the solenoid to the door. The solenoid has a piston 24 that extends from the solenoid body and extends/retracts as the solenoid is operated (the solenoid piston is extended in the view of FIG. 3). A cam-action latch mechanism includes a latch housing 26 and a solenoid latch 28, operative in the manner of a ballpoint pen clicker to latch in either an extended position or retracted position. The latch housing 26 and solenoid latch 28 carry interactive angled cam surfaces 29, 29′ operative to effect the clicker extension/retraction operation. An example of such pen clicker latch is disclosed in U.S. Pat. No. 3,205,863, issued Sep. 14, 1965, the disclosure of which is incorporated herein by reference. The solenoid latch presses against a translatable spring holder 30 which is movable back and forth along a direction of the bottom axis 32 of the door. The spring holder 30 mounts one end of a spring member 34, the other end of the spring being mounted to a fixed spring holder 36, which is mounted in a fixed position within the door.

At an opposite end of the mechanism from components described is a threaded member 38, with a nut 40 translatable along the threaded member, to allow for adjustment of the position of the mechanism in the door to achieve desired spring compression for operation. A contact member/sensor pair 42, 44 are provided in the door frame/door body to sense when the door is open or closed.

Operation of the mechanism is as follows. Assuming starting the door from a closed position, the configuration is as shown in FIG. 2, where the solenoid had been activated to extend the piston which depressed the cam mechanism so that spring holder 30 translated in the direction of arrow 46 of FIG. 2, and is held in that position by the cam position. This caused spring 34 to bow downwardly to the curved configuration, which causes the movable housing 14 to move downwardly by the spring pressing down, causing the seal 18 to engage the floor/threshold.

When the door is to be opened, the solenoid is activated to extend the piston to cause the cam mechanism to move so that the spring holder 30 translates in the direction of arrow 48. This causes the spring to cease its downward compression against the movable housing 14, whereby the housing moves upwardly in the direction of arrow 50. The movable housing is biased so as to move upwardly or is connected to the spring so as to move upwardly with the spring, thereby pulling the seal away from engagement with the floor/threshold.

For operating the door from the open position to the closed position, when frame contact/sensor 42 meets door contact/sensor 44, the solenoid will be activated by providing an electrical current which will force the solenoid piston forward to force the spring to make a belly action, which will lower the door bottom housing to the floor/threshold. The solenoid piston will push the solenoid latch out of the latch housing and create a partial rotation so when the spring forces it back, it will stay in its current position.

The contacts 42/44 could have a magnet to act as a door position switch, so that when it becomes demagnetized (door is open) the system will unlatch the piston so that it may depress back into the solenoid housing. The system may employ a power storage source, such as batteries, rechargeable or otherwise, capacitors or other power storage to activate the solenoid, where a second power storage (or more) acts as a back-up & time delay to activation. Thus, if the door is repeatedly opened and closed and there is not enough time to charge the 1^{st} storage, the second will perform the function instead of the first. Thus the mechanism is operable even if power is lost in the facility where the device is installed.

A side pin access hole may be provided for manual deactivation of the solenoid. The contacts/sensors 42/44 may be employed to give information as to door position (open/closed), and up/down position of the seal. A keypad/remote control may be provided to operate the open/close sealing functions.

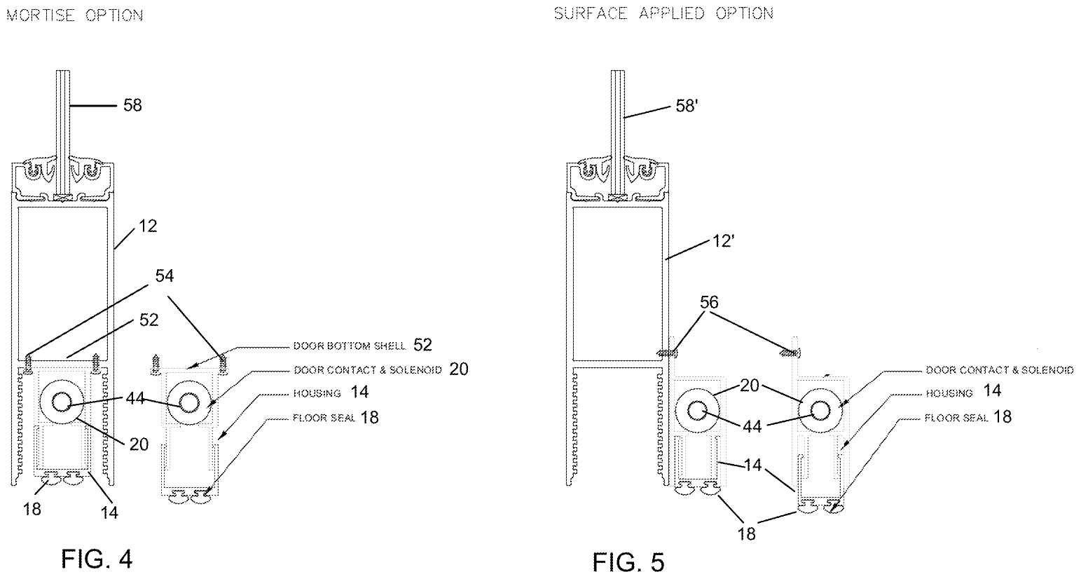

FIG. 4 is a view of the door mechanism of FIGS. 1-3 taken in the direction of 4-4 on FIG. 1 where the mechanism is installed in a door in a mortise configuration, wherein the door 12 has a bottom shell 52, which mounts the sealing mechanism therein, such as by mounting screws to secure the mechanism to the door shell. and

FIG. 5 is an end view of an alternative door mechanism where the mechanism is mounted to an external face of a door 12′ via mounting screws 56.

The doors 12, 12′ in FIGS. 4 and 5 are illustrated as having windows 58, 58′ as a part thereof.

Operation of the door seal mechanism is as follows:

When frame contact meets door contact, the current will force the solenoid piston forward to force the spring to make a belly action, which will lower the door bottom housing to the sill. The solenoid piston will push the solenoid latch out of the latch housing and create a partial rotation so when the spring forces it back it will stay in current position.

The contact can have a magnet (act as a door position switch (DPS)), so that when it becomes demagnetized (door is open) the battery/capacitor/etc. will unlatch the piston so that it may depress back into the solenoid housing. Second battery/capacitor/etc. (or more) to act as a back-up & time delay to activation. If door is repeatedly Opened and closed and not enough time to charge 1st battery/capacitor/etc., the second will perform the Function in instead of the first.

A side pin allows for manual deactivation of solenoid.

Door contact gives: door position, up/down position, keypad/remote control to activate.

Batteries/capacitors/etc.:

When door is closed the battery/capacitor/etc. get charged first then activate solenoid, the switch opens and current stops. This is when the spring forces the solenoid back and completes the clicker system partial rotation.

The battery/capacitor/etc. stay charged while the magnet is still in contact (DPS portion). When the door opens the magnet loses contact and forces the switch to close to allow battery/capacitor/etc. stored current to flow and activate solenoid, switch opens back, and another partial rotation in clicker system is finished to put it in open position.

Switch: employed because solenoid needs to retract back to allow clicker pen system to complete its rotation, so when current is lost the spring will push it inside the solenoid housing.

Repeat cycle.

In accordance with the disclosure, an improved mechanism for providing a sealing door is shown and described, where the door seal may be deployed or retracted to enable ease of operation of the door without having to fight against the friction of the seal with the floor/threshold.

While the illustrated embodiment has the sealing extension/retraction mechanism mounted to the door, an alternative embodiment can have the seal and extension/retraction mechanism mounted to the jamb or floor so as to engage the door from the jamb/floor, rather than having the seal engage the jamb/floor from the door.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

What is claimed is:

1. An extendable/retractable door seal, comprising:
a solenoid having an extendable/retractable piston member;
a cam-action latch that has an extended or retracted state by action of the piston member; and
an actuator operated by the cam action latch for extending or retracting a seal member for sealing a portion of an edge of a door against a jamb.

2. The extendable/retractable door seal according to claim 1, further comprising a sensor for detecting a change between an open/close state of the door to which said sealing member is mounted.

3. The extendable/retractable door seal according to claim 2, wherein said sensor comprises a magnetic sensor.

4. The extendable/retractable door seal according to claim 2, wherein said solenoid is activated in response to the detected change in the open/close state of the door.

5. The extendable/retractable door seal according to claim 1, wherein said actuator is electrically operated.

6. The extendable/retractable door seal according to claim 5, further comprising a first power storage for providing electrical power to operate said actuator.

7. The extendable/retractable door seal according to claim 6, further comprising at least one second power storage for providing further electrical power to operate said actuator in case said first power storage has insufficient charge to operate said actuator.

8. The extendable/retractable door seal according to claim 1, wherein the seal member extends or retracts from the door to the jamb.

9. The extendable/retractable door seal according to claim 1, wherein the seal member extends or retracts from the jamb to the door.

10. A door system, comprising:
a door;
an extendable/retractable door seal mounted to said door, said extendable/retractable door seal comprising:
a solenoid having an extendable/retractable piston member;
a cam-action latch that has an extended or retracted state by action of the piston member; and
an actuator operated by the cam action latch for extending or retracting a seal member for sealing a portion of an edge of a door against a jamb.

11. The door system according to claim 10, further comprising a sensor for detecting a change between an open/close state of the door.

12. The door system according to claim 11, wherein said sensor comprises a magnetic sensor.

13. The door system according to claim 11, wherein said solenoid is activated in response to the detected change in the open/close state of the door.

14. The door system according to claim 10, wherein said actuator is electrically operated.

15. The door system according to claim 14, further comprising a first power storage for providing electrical power to operate said actuator.

16. The door system according to claim 15, further comprising at least one second power storage for providing further electrical power to operate said actuator in case said first power storage has insufficient charge to operate said actuator.

17. The door system according to claim 10, wherein the seal member extends or retracts from the door to the jamb.

18. The door system according to claim 10, wherein the seal member extends or retracts from the jamb to the door.

19. A method of sealing a door, comprising:
providing an extendable/retractable door seal, to said door:
providing a solenoid having an extendable/retractable piston member;
providing a cam-action latch that has an extended or retracted state by action of the piston member; and
providing an actuator operated by the cam action latch for extending or retracting a seal member for sealing a portion of an edge of a door against a jamb.

20. The method according to claim 19, further comprising a sensor for detecting a change between an open/close state of the door to which said sealing member is mounted.
